(19) United States
(12) Patent Application Publication
(10) Pub. No.: US 2005/0268461 A1
(43) Pub. Date: Dec. 8, 2005

(54) Method and apparatus for securing turbine components for manufacture

(76) Inventors: Randall Maurice Ouellette, Proctor, VT (US); Stefan Andreas Moser, West Chester, OH (US); James Henry Madge, Erie, PA (US)

Correspondence Address: John S. Beulick;Armstrong Teasdale LLP, Suite 2600, One Metropolitan Square, St. Louis, MO, 63102, US

(21) Appl. No.: 10/862,545

(22) Filed: Jun. 7, 2004

(51) Int. Cl. B63H 1/20; F03B 3/12

(52) U.S. Cl. 29/889.7; 29/557

(57) ABSTRACT

An apparatus for machining a turbine blade assembly including an airfoil and a dovetail, wherein the apparatus includes a fixture, at least one airfoil locator, at least one airfoil clamp, and at least one dovetail clamp assembly. The airfoil locator and the airfoil clamp are fixedly coupled to the fixture. The airfoil locator and the airfoil clamp are configured to secure the airfoil therebetween. The dovetail clamp assembly includes a clamp arm that is moveable with respect to the dovetail.

### BACKGROUND OF THE INVENTION

This invention relates generally to manufacturing techniques and, more particularly, to methods and apparatus for securing turbine components for manufacture.

Accurate manufacturing of a turbine component may be a significant factor in determining a manufacturing time of the component. Specifically, when the component is a gas turbine engine blade, accurate manufacturing of the blade may be one of the most significant factors affecting an overall cost of fabrication of the gas turbine engine, as well as subsequent modifications, repairs, and inspections of the blade. For example, at least some known gas turbine engine blades include a dovetail that typically requires an accurate milling process to create the dovetail profile and under platform surfaces. To maintain an accurate relationship between the pressure faces of the dovetail, the fixture generally must be held as rigidly as possible to facilitate preventing movement of the dovetail during machining passes. Generally, any movement of the dovetail during the machining process may result in poor dimensional stability, degraded surface finish and/or reduced tool life

At least some known manufacturing processes encapsulate a cast gas turbine engine blade in an alloy that has low melting temperature, such as a tin-bismuth matrix. The encapsulate facilitates providing support to the blade during the machining process. However, such a material may not always enable accurate results to be produced, that are reliable or easily repeatable. More specifically, support facilitates preventing the blade from moving or deflecting due to the machining forces. In addition, using a matrix may require multiple fixtures, machines, and/or processes, thus increasing overall manufacturing time of the blade. Moreover, because the encapsulating material has to be cast around the airfoil, and then later removed, several non-value added steps are added to the manufacturing process.

### BRIEF DESCRIPTION OF THE INVENTION

In one aspect, a method is provided for securing a blade assembly for machining using an apparatus. The blade assembly has an airfoil, a dovetail and a platform extending therebetween. The method comprises providing a fixture having at least one airfoil locator coupled to the fixture, at least one airfoil clamp, and at least one dovetail clamp assembly, wherein each dovetail clamp assembly includes a moveable clamp arm. The method also comprises positioning the blade assembly within the fixture using the at least one airfoil locator such that the blade assembly is aligned by the airfoil locator with respect to the fixture. The method also comprises securing the airfoil within the fixture using the at least one airfoil clamp, and positioning the clamp arm against the dovetail such that the blade assembly is retained in alignment with respect to the fixture.

In another aspect, an apparatus is provided for machining a turbine blade assembly including an airfoil and a dovetail. The apparatus includes a fixture, at least one airfoil locator, at least one airfoil clamp, and at least one dovetail clamp assembly. The airfoil locator and the airfoil clamp are fixedly coupled to the fixture. The airfoil locator and the airfoil clamp are configured to secure the airfoil therebetween. The dovetail clamp assembly includes a clamp arm that is moveable with respect to the dovetail.

In a further aspect, a clamp assembly is provided. The clamp assembly includes an outer frame that defines a cavity therein, at least one clamp arm, at least one wedge member, and a biasing mechanism. The clamp arm extends at least partially into the cavity and is selectively moveable between a retracted position and an extended position. The wedge member is located at least partially within the cavity and is coupled to the clamp arm. The wedge member is configured to position the clamp arm with respect to the clamp assembly. The biasing mechanism is coupled to the wedge member, and is moveable between an extended position and a retracted position. The biasing mechanism is configured to move the clamp arm into an extended position.

### BRIEF DESCRIPTION OF THE DRAWINGS

FIG. 1 is a perspective view of an exemplary blade assembly for use in a gas turbine engine;

FIG. 2 is a perspective view of a fixture assembly used to secure a component, such as the blade assembly shown in FIG. 1, during a machining process;

FIG. 3 is a perspective view of a cutaway view of the fixture assembly shown in FIG. 2;

FIG. 4 is a side view of a dovetail clamp assembly portion of the fixture assembly shown in FIGS. 2 and 3; and

FIG. 5 is a side view of an internal portion of the fixture assembly shown in FIGS. 2 and 3.

### DETAILED DESCRIPTION OF THE INVENTION

As used herein, the terms “manufacture” and “manufacturing” may include any manufacturing process. For example, manufacturing processes may include grinding, finishing, polishing, cutting, machining, inspecting, and/or casting. The above examples are intended as exemplary only, and thus are not intended to limit in any way the definition and/or meaning of the terms “manufacture” and “manufacturing”. In addition, as used herein the term “component” may include any object to which a manufacturing process is applied. Furthermore, although the invention is described herein in association with a gas turbine engine, and more specifically for use with a turbine blade assembly for a gas turbine engine, it should be understood that the present invention may be applicable to any component and/or any manufacturing process. Accordingly, practice of the present invention is not limited to the manufacture of turbine blades or other components of gas turbine engines.

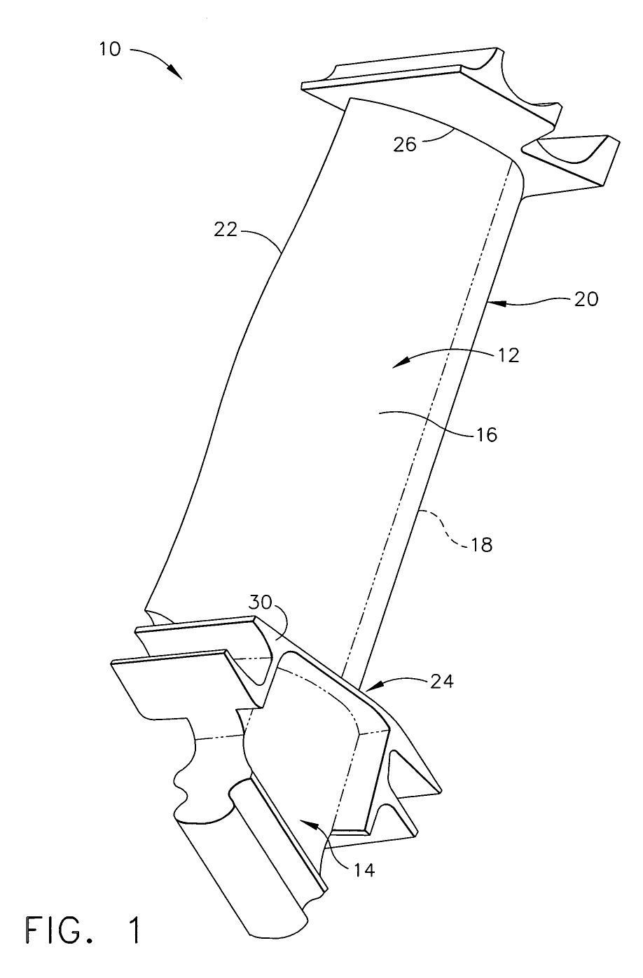

FIG. 1 illustrates a perspective view of a blade assembly 10 that may be used with a gas turbine engine (not shown). In one embodiment, a plurality of blade assemblies 10 form a high-pressure turbine rotor blade stage (not shown) of the gas turbine engine. Each blade assembly 10 includes a hollow airfoil 12 and an integral dovetail 14 that is used for mounting airfoil 12 to a rotor disk (not shown) in a known manner. Alternatively, blade assemblies 10 may extend radially outwardly from a disk (not shown), such that a plurality of blade assemblies 10 form a blisk (not shown).

Each airfoil 12 includes a first contoured sidewall 16 and a second contoured sidewall 18. First sidewall 16 is convex and defines a suction side of airfoil 12, and second sidewall 18 is concave and defines a pressure side of airfoil 12. Sidewalls 16 and 18 are joined at a leading edge 20 and at an axially-spaced trailing edge 22 of airfoil 12. More specifically, airfoil trailing edge 22 is spaced chordwise and downstream from airfoil leading edge 20. First and second sidewalls 16 and 18, respectively, extend longitudinally or radially outward in span from a blade root 24 positioned adjacent dovetail 14, to an airfoil tip 26. A dovetail platform 30 is positioned at blade root 24 and extends radially outward from first and second sidewalls 16 and 18, respectively.

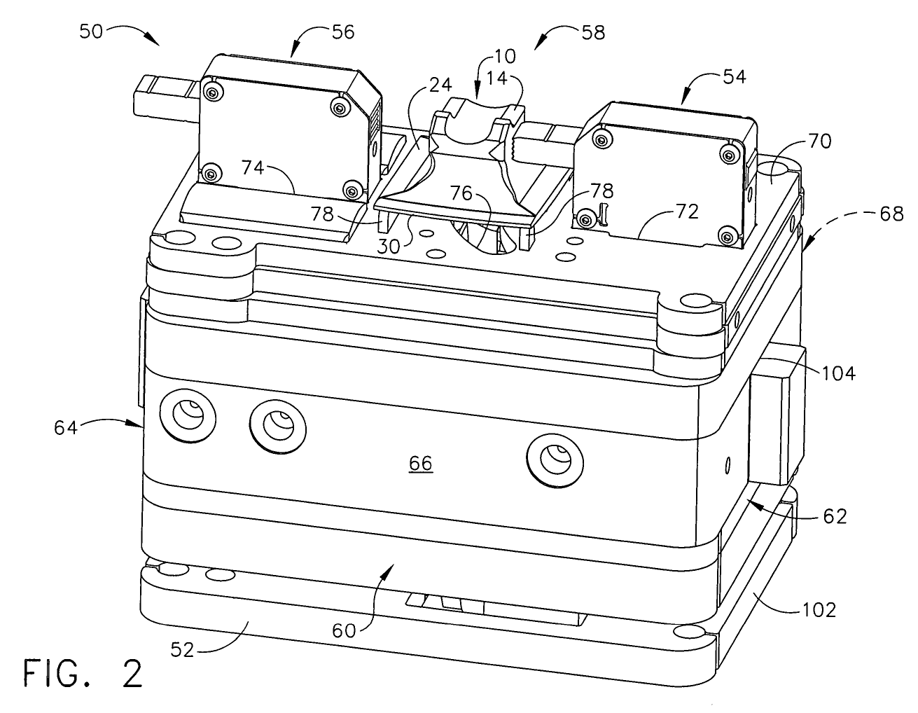

FIG. 2 illustrates an exemplary embodiment of a fixture assembly 50 that may be used to secure a component, such as blade assembly 10, during a manufacturing process. Fixture assembly 50 includes a fixture 52 used for manufacturing processes, a first dovetail clamp assembly 54 coupled to fixture 52, a second dovetail clamp assembly 56 coupled to fixture, and a securing assembly 58 used for securing a blade assembly 10 in position prior to the manufacturing process.

First and second dovetail clamp assemblies 54 and 56, are coupled to fixture assembly 50 using any suitable coupling means. For example, in one embodiment, at least one of first and second dovetail clamp assembly 54 and 56 is coupled to fixture 52 using threaded bolts and threaded nuts. In another embodiment, at least one of first and second dovetail clamp assembly 54 and 56 is coupled to fixture 52 using threaded bolts and threaded openings in fixture 52.

Fixture 52 includes an outer casing 60 having a first end wall 62, a second end wall 64, side walls 66 and 68 extending therebetween, and an upper surface 70 that extends between opposing side walls 66 and 68 and between end walls 62 and 64. Surface 70 is coupled to fixture 52 using any suitable coupling means such as, for example, using threaded bolts and threaded nuts or alternatively using threaded bolts and threaded openings in fixture 52.

Openings 72 and 74 extend through top surface 70 and are proximate respective end walls 62 and 64 to enable first dovetail clamp assembly 54 and second dovetail clamp assembly 56, respectively, to extend beyond top surface 70. Moreover, openings 72 and 74 enable clamp assemblies 54 and 56 to be positioned for retaining blade assembly 10 during the manufacturing process. Prior to undergoing a manufacturing process, blade assembly 10 is secured with fixture assembly 50. Accordingly, a blade assembly opening 76 extending through top surface 70 and between openings 72 and 74, is sized to enable a blade assembly 10 to be loaded into fixture 52, and more particularly, into securing assembly 58, as is described in more detail below. A plurality of platform supports 78 extend from top surface 70 and engage platform 30. Platform supports 78 facilitate positioning blade assembly 10 in alignment relative to fixture assembly 50, such that blade assembly 10 is retained by securing assembly 58, and more specifically, is retained by first and second dovetail clamp assemblies 54 and 56.

In use, dovetail 14 is positioned and aligned by securing assembly 58, and is retained in alignment by first and second dovetail assemblies 54 and 56, respectively. Accordingly, the combination of dovetail clamp assemblies 54 and 56, and securing assembly 58 facilitates locating, securing, and retaining blade assembly 10 in alignment with respect to fixture 52 during manufacturing of blade assembly 10.

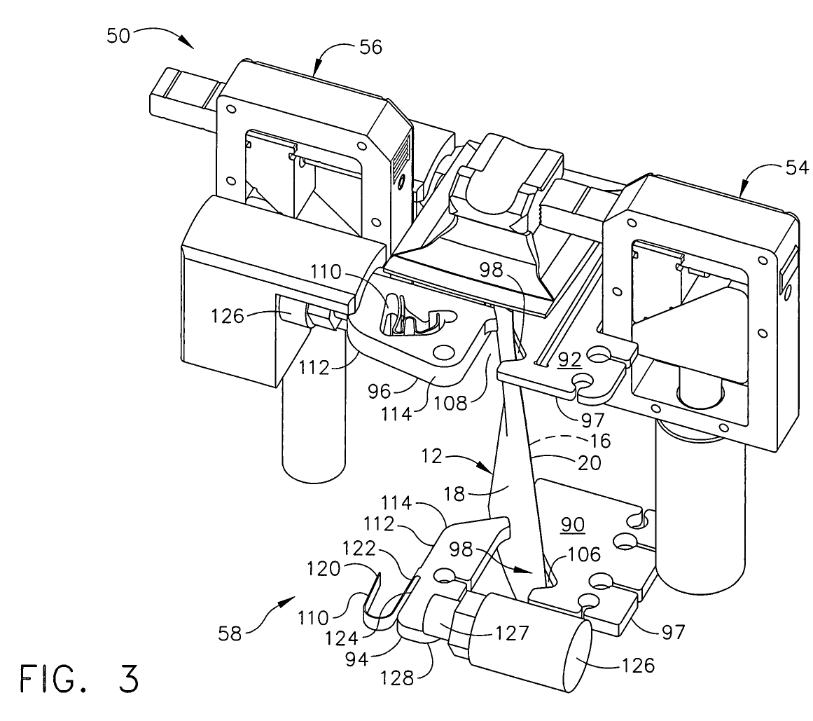

FIG. 3 is a perspective view of a partially cutaway view of fixture assembly 50, and more specifically, illustrates the alignment of second side wall 18, or the concave side, of airfoil 12 with respect to first dovetail clamp assembly 54, second dovetail clamp assembly 56, and securing assembly 58. Securing assembly 58 includes first and second airfoil locators 90 and 92, respectively, and first and second airfoil clamps 94 and 96, respectively. Each airfoil locator 90 and 92 has a base 97 that is fixedly coupled to fixture 52. A cavity 98 is defined within base 97 and is sized to receive at least a portion of airfoil 12 therein. First airfoil locator 90 is positioned adjacent to a lower portion 102 of fixture assembly 50, and second airfoil locator 92 is proximate to an upper portion 104 of fixture assembly 50. In an alternative embodiment, additional airfoil locators (not shown) are coupled to fixture 52 and are positioned either between first and second airfoil locators 90 and 92, and/or below, or above, first and second airfoil locators 90 and 92, respectively.

In the exemplary embodiment, airfoil 12 is positioned within first airfoil locator cavity 106 such that leading edge 20, and a portion of first side wall 16 and second side wall 18, are located within cavity 106 and secured therein by first airfoil clamp 94. Airfoil 12 is also secured by second airfoil locator 92 and second airfoil clamp 96 such that airfoil 12 is positioned within second airfoil locator cavity 108. Specifically, when airfoil 12 is within cavity 108, leading edge 20 and a portion of first and second side walls 16 and 18, respectively, are positioned within cavity 106 and secured therein by second airfoil clamp 94. In the exemplary embodiment, first airfoil clamp 92 is biased against first side wall 16, and second airfoil clamp 94 is biased against second sidewall 18. In an alternative embodiment, first airfoil clamp 92 is biased against second sidewall 18, and second airfoil clamp 94 is biased against first side wall 16. In another alternative embodiment, both airfoil clamps 92 and 94 are biased against the same side wall 16 or 18.

First and second airfoil clamps 94 and 96 each include a base member 112 that has an outer perimeter 114 that is contoured to substantially mate against blade assembly 10, when blade assembly 10 is inserted into fixture assembly 50. Airfoil clamps 94 and 96 are each biased against airfoil 12 by a biasing mechanism 110 and a hydraulic piston 126. Biasing mechanism 110 engages a first side 124 of each airfoil clamp 94 and 96, and hydraulic piston 126 engages an opposing second side 128 of each airfoil clamp 94 and 96. In the exemplary embodiment, biasing mechanism 110 has a first end 120 coupled to fixture 52, and a second end 122 coupled to base member first side 124. Each hydraulic piston 126 includes a rod 127 that extends therefrom to engage base member second side 128. When hydraulic piston 126 is activated, rod 127 is extended outwardly a distance, thus enabling airfoil clamp 94 or 96 to secure airfoil 12 within cavity 106. When the pressure is removed from piston 126, rod 127 is moved in the opposite direction and biasing mechanism 110 biases against airfoil clamp 94 or 96 until airfoil clamp 94 or 96 is in a resting position. In an alternative embodiment, biasing mechanism 110 is sized to secure airfoil 12 in position without the use of hydraulic piston 126.

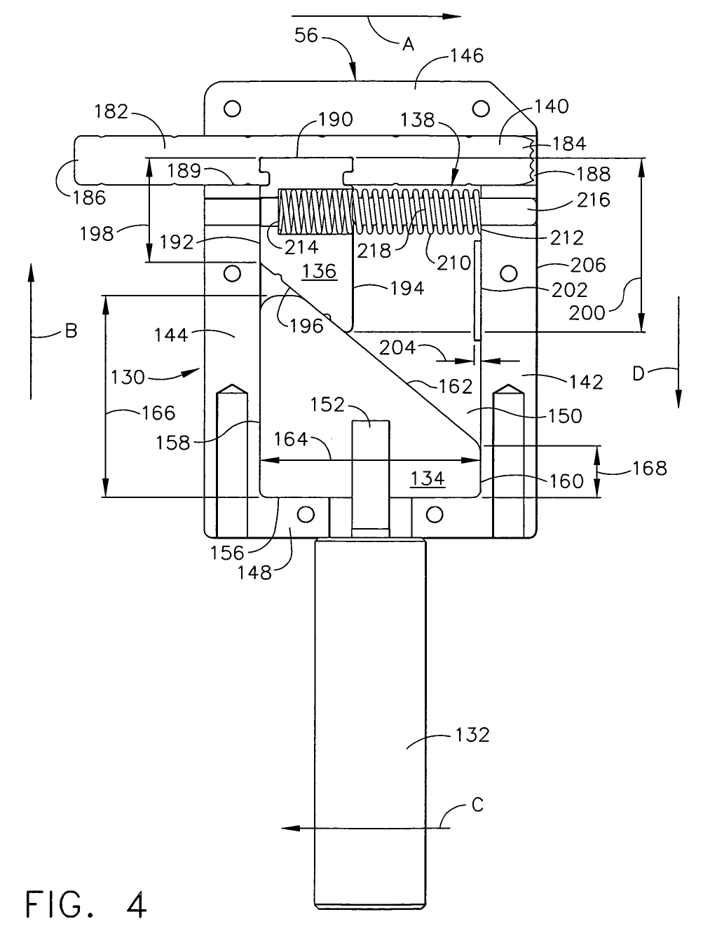

FIG. 4 is a side view of dovetail clamp assembly 56 in a retracted position. Although FIG. 4 is described in terms of second dovetail clamp assembly 56, it should be noted that first dovetail clamp assembly 54 functions in a substantially similar manner. In the exemplary embodiment, dovetail clamp assembly 56 includes a frame 130, a hydraulic piston 132, a piston wedge 134, a clamp arm wedge 136, a biasing mechanism 138, and a clamp arm 140. Frame 130 includes an inner side wall 142 and an opposing outer side wall 144, opposing top and bottom walls 146 and 148, respectively, and an inner cavity 150 that is defined therebetween. Inner cavity 150 houses the working components of dovetail clamp assembly 56.

Hydraulic piston 132 is coupled to fixture 52 and includes a rod 152 which extends through frame 130 and contacts piston wedge 134. In the exemplary embodiment, rod 152 is coupled to piston wedge 134. Piston wedge 134 is housed within inner cavity 150 and includes a bottom wall 156, an outer side wall 158, an inner side wall 160 and a top wall 162. Bottom wall 156 has a width 164 which is substantially equal to the distance of separation between frame inner and outer side walls 142 and 144. Wedge outer side wall 158 has a height 166 which is greater than a height 168 of wedge inner side wall 160 such that top wall 162 is obliquely oriented with respect to wedge side walls 158 to 160.

Clamp arm 140 includes an elongated body 182 that extends from a first end 184 to a second end 186, such that first end 182 is proximate to, and extends through, a first bore 188 defined in frame side wall 142, and such that second end 186 is proximate to, and extends through, a second bore 189 defined in frame side wall 144. Clamp arm first end 184 has a contoured surface 187 for mating against a portion of dovetail 14 when activated. Clamp arm 140 is positioned at least partially within frame inner cavity 150, and, in the exemplary embodiment, is bounded by frame top wall 146. Clamp arm wedge 136 is coupled to clamp arm 140.

Clamp arm wedge 136 is housed within inner cavity 150 and includes a top wall 190, an outer side wall 192, an inner side wall 194 and a bottom wall 196. Top wall 190 is coupled to clamp arm 140 and is fixed relative to clamp arm first end 184 and second end 186. Top wall 190 extends a width 164 which is narrower than the separation distance between frame side walls 142 and 144, such that clamp arm wedge 136 is moveable substantially parallel to frame top wall 146 between outer sidewall 144 and inner sidewall 142, as hydraulic piston 132 is activated. Wedge outer side wall 192 has a height 198 which is shorter than a height 200 of wedge inner side wall 194, such that bottom wall 196 extends obliquely downward from wedge outer side wall 192 to wedge inner side wall 194. Clamp arm wedge bottom wall 196 is moveable with respect to piston wedge top wall 162 and is obliquely oriented similarly to piston wedge top wall 162 to facilitate sliding movement between walls 162 and 196.

In the exemplary embodiment, when dovetail clamp assembly 56 is in a deactivated or retracted position, piston wedge 134 is positioned adjacent to frame bottom wall 148, and clamp arm wedge 136 is positioned adjacent to frame outer side wall 144. In this position, clamp arm first end 184 is substantially housed within first bore 188 and is substantially flush with outer perimeter 206 of inner side wall 142. In this position, clamp arm second end 186 is located a distance from frame outer side wall 144. When hydraulic piston 132 is activated, rod 152 extends outward and forces piston wedge 134 in the direction of Arrow B towards frame top wall 146. As piston wedge 134 is translated, clamp arm wedge 136 is forced in the direction of Arrow A, towards frame inner side wall 142, as a result of the interfacing of walls 162 and 196 of respective wedges 134 and 136. Furthermore, because of the orientation of wedges 134 and 136, with respect to respective walls 162 and 196, each respective wedge 134 and 136 can only be shifted in the vertical and horizontal directions, respectively.

In the exemplary embodiment, when second dovetail clamp assembly 56 is in the activated or extended position, piston wedge 134 is positioned a distance from frame bottom wall 148, and clamp arm wedge 136 is positioned adjacent to frame inner side wall 142. In this position, clamp arm second end 186 is contained within second bore 189 and is substantially flush against outer side wall 144. Clamp arm first end 186 interfaces with dovetail 14, as will be described in detail below. In the exemplary embodiment, dovetail clamp assembly 56 includes a shim 202 that is positioned along frame inner side wall 142 and has a thickness 204 that substantially restricts horizontal movement of clamp arm wedge 136 in the direction of Arrow A when clamp arm first end 186 is against dovetail 14.

In the exemplary embodiment, biasing mechanism 138 includes a spring member 210 that has a first end 212 coupled to frame inner side wall 142 and a second end 214 coupled to clamp arm wedge 136. Spring member 210 is contained within frame 130 and has a retention beam 216 that extends from frame side walls 142 to 144 through a bore 218 defined in spring member 210. Spring member 210 biases against side wall 142 and clamp arm wedge 136. Biasing mechanism 138 biases clamp arm wedge 136 in the direction of Arrow C which forces clamp arm wedge 136 to move in the direction of Arrow C when hydraulic piston 132 is de-activated. As clamp arm wedge 136 is repositioned, piston wedge 134 is forced in the direction of Arrow D towards frame bottom wall 148 until second dovetail clamp assembly 56 returns to the retracted or deactivated position. However, as described above, when hydraulic piston 132 is activated, the hydraulic force of piston 132 forces second dovetail clamp assembly 56 into the extended or activated position. In the exemplary embodiment, biasing mechanism 210 extends at least partially through a bore 220 defined in clamp arm wedge 136.

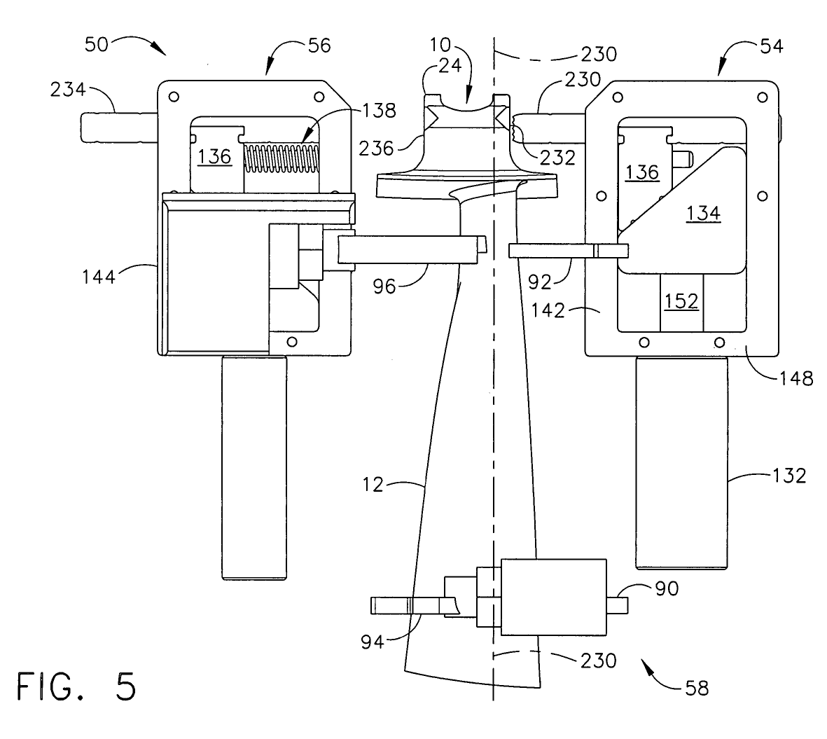

FIG. 5 is a side view of a portion of fixture assembly 50 showing blade assembly 10, first dovetail clamp assembly 54, second dovetail clamp assembly 56, and securing assembly 58. Fixture assembly 50 facilitates locating, securing, and retaining blade assembly 10 in alignment with respect to fixture 52 during manufacturing of blade assembly 10. Blade assembly 10 is secured relative to fixture assembly 50 by securing assembly 58. More specifically, in the exemplary embodiment, airfoil 12 is biased against airfoil locators 90 and 92 by airfoil clamps 94 and 96. Airfoil clamps 94 and 96 are secured in position by biasing mechanisms 110 which are activated by hydraulic pistons 126.

After blade assembly 10 is secured in place, dovetail clamp assemblies 54 and 56 facilitate retaining dovetail 14 in a fixed position during the manufacturing process. First dovetail clamp assembly 54 is activated to cause first clamp arm 230 to extend along a substantially linear path and contact dovetail 14 at a first contact point 232. In the exemplary embodiment, first dovetail clamp assembly 54 includes shim 202 that facilitates orienting first dovetail clamp assembly 54 as a datum. Second dovetail clamp assembly 56 is then activated to cause second clamp arm 234 to extend along a substantially linear path and contact dovetail 14 at a second contact point 236, which is generally opposed from first contact point 232. Once clamp arms 230 and 234 are activated, dovetail 14 is retained therebetween. In the exemplary embodiment, clamp arms 230 and 234 extend along the same substantially co-linear path. In an alternative embodiment, at least one clamp arm 230 and/or 234 is rotatable such that clamp arm 230 and/or 234 extends along a curvilinear path.

As illustrated in FIG. 5, first dovetail clamp assembly 54 is in an extended, or activated, position and clamp arm 230 is positioned against a portion of dovetail 14. In this position, hydraulic piston 132 has been activated, rod 152 is extended, and piston wedge 134 is in an elevated position relative to frame bottom wall 148. Accordingly, clamp arm wedge 136 is adjacent to inner side wall 142 and clamp arm 230 has been repositioned toward dovetail 14. Second dovetail clamp assembly 56 is in a retracted, or de-activated, position such that clamp arm 234 is positioned a distance from dovetail 14. Biasing mechanism 138 has been extended to force clamp arm wedge 136 adjacent to frame outer wall 144.

The above-described fixture assembly is cost-effective and highly reliable for securing a component during manufacturing. The fixture assembly permits a blade dovetail to be secured during manufacturing. More specifically, the fixture assembly rigidly secures the blade dovetail in a position without requiring an encapsulate. The fixture assembly may also facilitate securing a blade dovetail during manufacturing without the use of multiple machines, fixtures, and/or processes. Because the blade may be self-oriented once coupled to the tool, the tool requires minimal input from an operator. As a result, the tool facilitates reducing manufacturing costs in a cost-effective and reliable manner.

Exemplary embodiments of fixture assemblies are described above in detail. The assemblies are not limited to the specific embodiments described herein, but rather, components of each assembly may be utilized independently and separately from other components described herein. Each fixture assembly component can also be used in combination with other tool assembly components.

While the invention has been described in terms of various specific embodiments, those skilled in the art will recognize that the invention can be practiced with modification within the spirit and scope of the claims.

1. A method for securing a blade assembly for machining, wherein the blade assembly includes an airfoil, a dovetail, and a platform extending therebetween, said method comprising:
providing a fixture having at least one airfoil locator coupled to the fixture, at least one airfoil clamp, and at least one dovetail clamp assembly, wherein each dovetail clamp assembly includes a moveable clamp arm;
positioning the blade assembly within the fixture using the at least one airfoil locator such that the blade assembly is aligned by the airfoil locator with respect to the fixture;
securing the airfoil within the fixture using the at least one airfoil clamp; and
positioning the clamp arm against the dovetail such that the blade assembly is retained in alignment with respect to the fixture.

2. A method in accordance with claim 1 wherein positioning the blade assembly further comprises positioning a piston against the airfoil clamp to facilitate securing the airfoil with the airfoil locator.

3. A method in accordance with claim 1 wherein providing a fixture further includes providing a first dovetail clamp assembly having a moveable first clamp arm, and a second dovetail clamp assembly having a moveable second clamp arm.

4. A method in accordance with claim 3 wherein positioning the clamp arm against the dovetail further comprises repositioning the first clamp arm along a first substantially linear path of travel with respect to the dovetail.

5. A method in accordance with claim 3 wherein positioning the clamp arm against the dovetail further comprises repositioning the second clamp arm along a second substantially linear path of travel with respect to the dovetail.

6. A method in accordance with claim 3 wherein positioning the clamp arm against the dovetail further comprises positioning the first and second clamp arms along the same substantially co-linear path of travel such that the first and second clamp arms engage opposing sides of the dovetail.

7. A method in accordance with claim 3 wherein positioning the clamp arm against the dovetail further comprises activating a hydraulic piston to reposition a wedge coupled to the clamp arm towards the dovetail along a substantially linear path.

8. A method in accordance with claim 3 further comprising releasing the dovetail such that a biasing mechanism coupled to the clamp arm biases the clamp arm away from the dovetail.

9. An apparatus for machining a turbine blade assembly including an airfoil and a dovetail, said apparatus comprising:
a fixture;
at least one airfoil locator fixedly coupled to said fixture;
at least one airfoil clamp coupled to said fixture, said airfoil locator configured to cooperate with said airfoil clamp to secure the airfoil therebetween; and
at least one dovetail clamp assembly comprising a clamp arm that is moveable with respect to said fixture and the dovetail.

10. An apparatus in accordance with claim 9 wherein said at least one dovetail clamp assembly comprises a first dovetail clamp assembly comprising a first clamp arm, and a second dovetail clamp assembly comprising a second clamp arm, said second clamp arm is moveable to facilitate retaining the dovetail between said first and second dovetail clamp assemblies.

11. An apparatus in accordance with claim 9 wherein said first clamp arm is movable along a first substantially linear path of travel with respect to the dovetail.

12. An apparatus in accordance with claim 9 wherein said second clamp arm is movable along a substantially linear path of travel with respect to the dovetail.

13. An apparatus in accordance with claim 9 wherein said first clamp arm and said second clamp arm are movable along the same substantially co-linear path of travel with respect to the dovetail.

14. An apparatus in accordance with claim 9 wherein said first and second dovetail clamp assemblies further comprise a hydraulic assembly coupled to each said clamp arm, each said clamp arm is moveable along a substantially linear path of travel.

15. An apparatus in accordance with claim 9 wherein said first and second dovetail clamp assemblies further comprise a biasing mechanism coupled to each said clamp arm, such that each said biasing mechanism biases each said clamp arm away from the dovetail.

16. A clamp assembly comprising:
an outer frame defining a cavity therein;
at least one clamp arm extending at least partially within said cavity and selectively moveable between a retracted position and an extended position;
at least one wedge member located at least partially within said cavity and coupled to said clamp arm, said at least one wedge member configured to position said clamp arm with respect to said clamp assembly; and
a biasing mechanism coupled to said wedge member, said biasing mechanism moveable between an extended position and a retracted position, said biasing mechanism configured to bias said clamp arm into the extended position.

17. A clamp assembly in accordance with claim 16 wherein said clamp arm is configured to retain a dovetail portion of a blade assembly when said clamp arm is in the extended position.

18. A clamp assembly in accordance with claim 16 wherein said at least one wedge member further comprises a clamp arm wedge and a piston wedge, said clamp arm wedge is coupled to said clamp arm, said piston wedge is coupled to said biasing mechanism such that said biasing mechanism and said piston wedge forces said clamp arm wedge along a substantially linear path.

19. A clamp assembly in accordance with claim 16 wherein said biasing mechanism comprises a hydraulic piston.

20. A clamp assembly in accordance with claim 16 further comprising a spring mechanism coupled to said at least one wedge member, said spring mechanism configured to move said wedge into a retracted position.
